(19) United States
(12) Patent Application Publication
(10) Pub. No.: US 2010/0254127 A1
(43) Pub. Date: Oct. 7, 2010

(54) LED-based lighting module for emitting white light with easily adjustable color temperature

(76) Inventor: Kai-Ren Yang, Taichung City (TW)

Correspondence Address: CHARLES E. BAXLEY, ESQUIRE, 90 JOHN STREET, SUITE 309, NEW YORK, NY, 10038, US

(21) Appl. No.: 12/384,145

(22) Filed: Apr. 1, 2009

(51) Int. Cl. F21V 9/00

(52) U.S. Cl. 362/231

(57) ABSTRACT

Disclosed is an LED white-light lamp with an easily adjustable color temperature. The LED white-light lamp includes a substrate, a plurality of red LED packages, a plurality of green LED packages, a plurality of blue LED packages, a lampshade and a conductive device. The red, green and blue LED packages are provided on the substrate. Each of the red, green and blue LED packages includes an LED chip for emitting red, green or blue light, a cover for covering the LED chip and a plurality of scattering particles scattered in the cover. The lampshade is connected to the periphery of the substrate to block undesired senses of direction of light emitted from the LED packages. The conductive device is connected to the lampshade and the substrate to supply electricity to the red, green and blue LED chips from an external power supply to actuate the LED chips to emit the red, green and red light that is mixed into white light.

### BACKGROUND OF INVENTION

1. Field of Invention

The present invention relates to a lighting module and, more particularly, to an LED-based lighting module for emitting white light with easily adjustable color temperature.

2. Related Prior Art

A light-emitting diode (“LED”) is low in consumption of energy and high in efficiency of illumination. Therefore, a lot of efforts have been made on LEDs for illumination.

Referring to FIG. 1, a conventional LED-based lighting module includes a red LED 1, a green LED 2 and a blue LED 3 connected to a circuit board 4. The circuit board 4 is connected to a terminal for connection to the mains or a socket of a lighting module. Red light, green light and blue light are mixed into white light. Wavelengths and intensities must be selected carefully. Therefore, the mixture is difficult, and white light only exists in a central zone where red, green and blue light beams overlap. The light turns to red, green and blue in areas away from the central zone. That is, there are color blocks.

Referring to FIG. 2, another conventional LED-based lighting module includes a red LED 1, a green LED 2 and a blue LED 3 connected to a circuit board 4. The circuit board 4 is connected to a terminal for connection to the mains or a socket of a lighting module. A lens 5 is located in front of the circuit board 4. The lens 5 is added with fluorescent powder 6 for mixing red light, green light and blue light into white light. However, the angle of the white light is limited. Moreover, the LEDs 1, 2 and 3 generate a lot of heat as a byproduct while emitting light. The fluorescent powder 6 is however vulnerable to heat and deteriorates with rising temperature so that there is serious optical decay.

Furthermore, the wavelength of light from an LED is determined by the structure of and materials used in an epitaxial layer and, most importantly, matching of lattices. Hence, there is serious drift of the wavelength because of high temperature of semiconductor. When the LED-based lighting module is just turned on, it emits reddish white light because the efficiency of the red LED 1 is high. After some time, it emits bluish white light for increasing efficiency of the blue LED 3. The color temperature has changed. As shown in the spectrum, the thermal drift to a cold color from a warm color is too big to retain white balance of the color-mixture and the luminance of the light.

Another conventional LED-based lighting module includes a white LED as a primary light source and red, green and blue LEDs for compensating the color temperature of light emitted from the white LED. That is, at least one of the red, green and blue LEDs is turned on and the intensity thereof is controlled to compensate the color temperature of the light emitted from the white LED when there is optical decay because of deteriorating of fluorescent powder used in the white LED. However, the color temperature cannot be compensated precisely. Moreover, the control over the intensity of an LED by the control over a current provided to the LED is difficult.

The present invention is therefore intended to obviate or at least alleviate the problems encountered in prior art.

### SUMMARY OF INVENTION

It is the primary objective of the present invention to provide an LED-based lighting module for emitting white light with easily adjustable color temperature

To achieve the foregoing objective, the lighting module includes a substrate and at least three red light-emitting diode packages, three green light-emitting diode packages and three blue light-emitting diode packages provided on the substrate. Each of the light-emitting diode packages includes a light-emitting diode chip, a lens for wrapping the light-emitting diode chip and scattering particles spread in the lens. A lampshade is used to support the substrate. A conductive device is connected to the lampshade and electrically connected to the substrate for conducting electricity to the substrate from an external power supply.

Other objectives, advantages and features of the present invention will become apparent from the following description referring to the attached drawings.

### BRIEF DESCRIPTION OF DRAWINGS

The present invention will be described via detailed illustration of embodiments versus prior art referring to the drawings.

FIG. 1 is a cross-sectional view of a conventional LED-based lighting module.

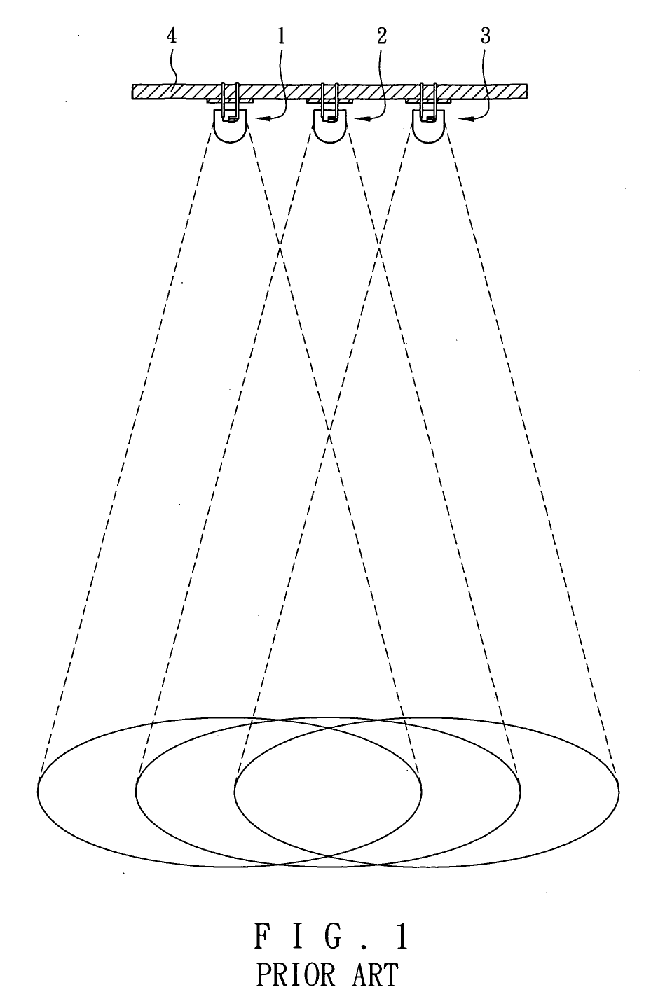

FIG. 2 is a cross-sectional view of another conventional LED-based lighting module.

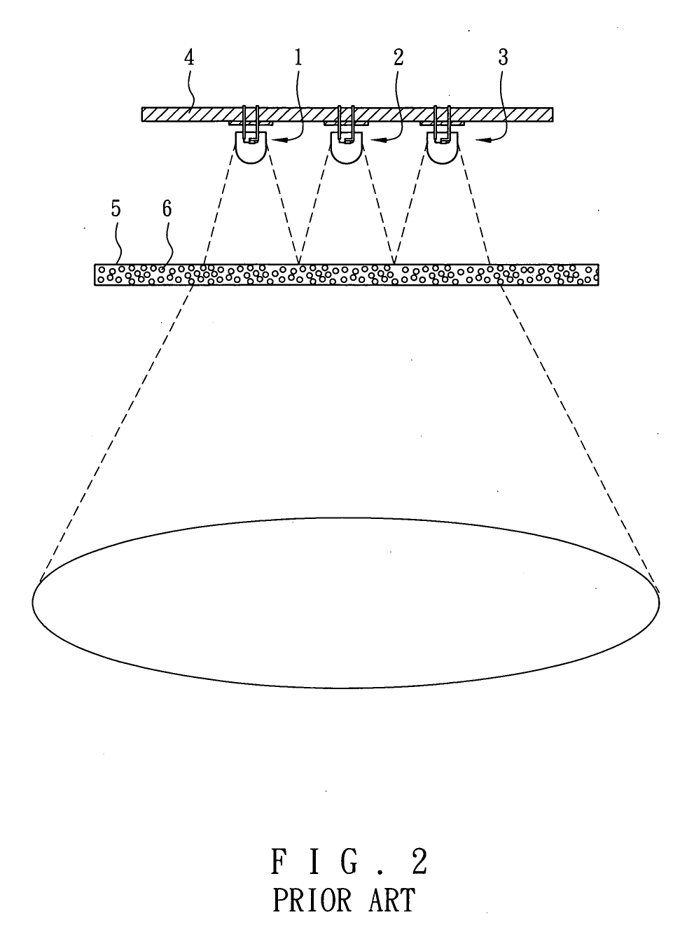

FIG. 3 is a perspective view of an LED-based lighting module according to a first embodiment of the present invention.

FIG. 4 is a cross-sectional view of the LED-based lighting module shown in FIG. 3.

FIG. 5 is a perspective view of an LED-based lighting module according to a second embodiment of the present invention.

FIG. 6 is a perspective view of an LED-based lighting module according to a third embodiment of the present invention.

FIG. 7 is a perspective view of an LED-based lighting module according to a fourth embodiment of the present invention.

FIG. 8 is a perspective view of an LED-based lighting module according to a fifth embodiment of the present invention.

FIG. 9 is a perspective view of an LED-based lighting module according to a sixth embodiment of the present invention.

### DETAILED DESCRIPTION OF PREFERRED EMBODIMENT

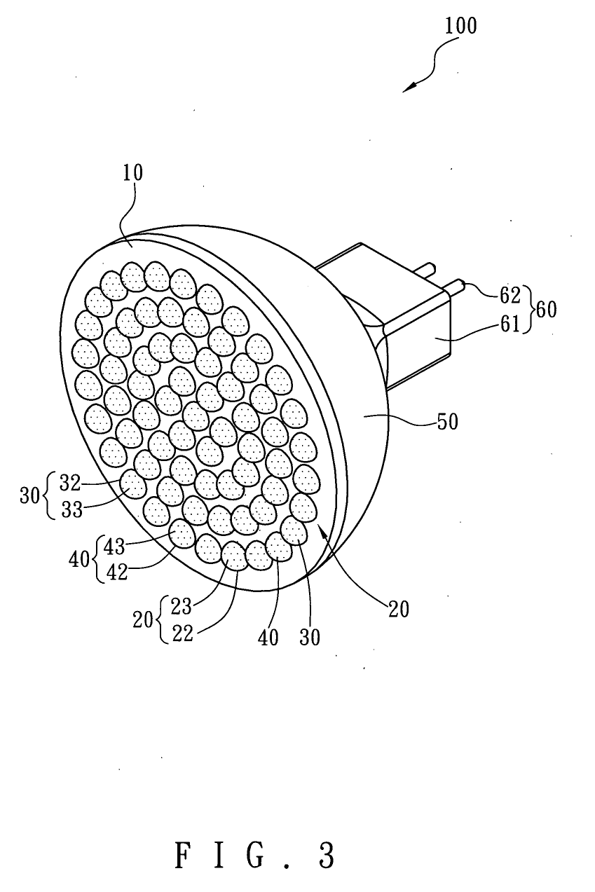

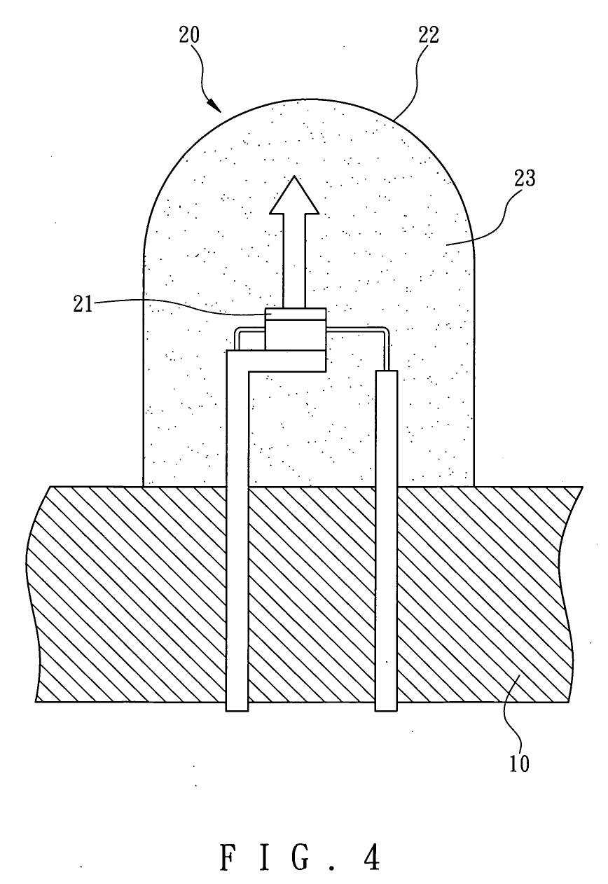

Referring to FIGS. 3 and 4, an LED-based lighting module 100 includes a substrate 10, red LED packages 20, green LED packages 30, blue LED packages 40, a lampshade 50 and a conductive device 60 according to a first embodiment of the present invention. The substrate 10 is a printed circuit board with predetermined wiring.

Each of the red LED packages 20 includes a red LED chip 21, a lens 22 and scattering particles 23. Given a certain current, the red LED chip 21 emits red light. The lens 22 is made of a transparent material such as epoxy, silicone and glass. The lens 22 is used to wrap the LED chip 21. The scattering particles 23 are scatter in the lens 22. The red LED packages 20 are provided on the substrate 10, in predetermined positions. The red LED packages 20 are electrically connected to the substrate 10 so that the former is actuated to emit red light with electricity from the latter.

Similarly, each of the green LED packages 30 includes a green LED chip, a lens 32 and scattering particles 33. The GL LED packages 30 are electrically connected to the substrate 10. The GL LED packages 30 are located in predetermined positions on the substrate 10.

Similarly, each of the blue LED packages 40 includes a blue LED chip, a lens 42 and scattering particles 43. The BL LED packages 40 are electrically connected to the substrate 10. The BL LED packages 40 are located in predetermined positions on the substrate 10.

The scattering particles used in the LED packages 20, 30 and 40 are made of at least one highly reflective or scattering material. For example, they can be made of silver, calcium carbonate (CaCO₃) and/or silicon dioxide (SiO₂), alone or in combination with resin.

The lampshade 50 is made of an opaque material. The lampshade 50 is provided around the substrate 10 for support and protection. The lampshade 50 is located on a non-illuminating side of the LED packages 20, 30 and 40.

The conductive device 60 includes a shell 61 and two pins 62. The shell 61 is made of an isolating material. The pins 62 are made of a conductive material. The shell 61 is connected to the lampshade 50. The pins 62 are extended through the shell 61, i.e., each of the pins 62 is formed with an end electrically connected to the substrate 10 and another end for electric connection to a socket of the mains for example. Thus, electricity can be provided to the LED packages 20, 30 and 40 from the mains through the pins 62 and the substrate 10.

The red LED packages 20 emit red light beams. The green LED packages 30 emit green light beams. The blue LED packages 40 emit blue light beams. The numbers and positions of the scattering particles disposed in the lens of each of the LED packages 20, 30 and 40 is carefully determined so that the scattering particles cause the LED packages 20, 30 and 40 to cast similar light beams that almost completely overlap one another, leaving small color blocks. The color blocks are too small to be observed by humans. That is, the red light, the green light and the blue light are well mixed into white light. The numbers and positions of the scattering particles respectively used in the LED packages 20, 30 and 40 are different from one another.

Furthermore, since there are several red LED packages 20, several green LED packages 30 and several blue LED packages 40 on the substrate 10, they can be replaced with one another or their positions can be changed to adjust the color temperature from cold to warm. For example, color temperature for indoor use can be different from color temperature for outdoor use. The color temperature of the light emitted from the lighting module 100 can easily be adjusted without having to use a complicated mechanism to change currents or voltages provided to the LED packages.

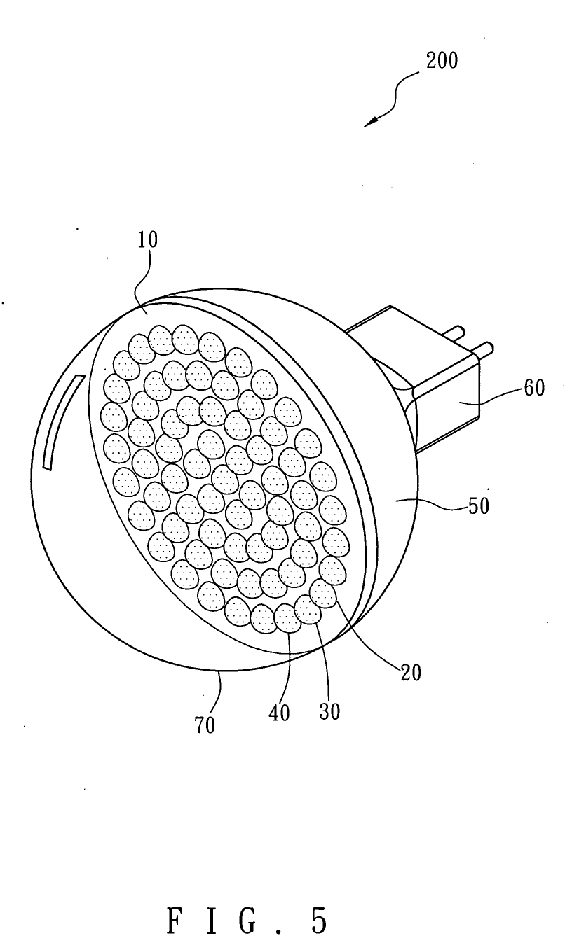

Referring to FIG. 5, shown is an LED-based lighting module 200 according to a second embodiment of the present invention. The LED-based lighting module 200 is identical to the LED-based lighting module 100 except including an additional light-enhancing element 70 connected to the lampshade 50, over the LED packages 20, 30 and 40. The light-enhancing element 70 is made of a transparent material such as epoxy, silicone and glass. The light-enhancing element 70 is used to concentrate the light from the LED packages 20, 30 and 40 so that the light travels far. The light-enhancing element 70 is a dome.

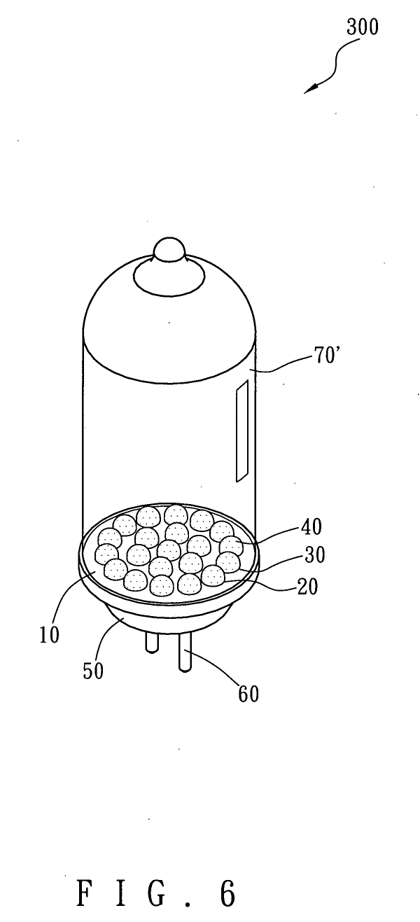

Referring to FIG. 6, shown is an LED-based lighting module 300 according to a third embodiment of the present invention. The LED-based lighting module 300 is identical to the LED-based lighting module 200 except including a light-enhancing element 70′ instead of the light-enhancing element 70.

In the LED-based lighting modules 200 and 300, light-enhancing elements 70 and 70′ are used, respectively. However, a scattering element may be used instead of the light-enhancing elements in another embodiment. The scattering element includes a panel and scattering particles scattered in the panel. The panel is made of a transparent material such as epoxy, silicone and glass. The scattering particles are made of at least one highly reflective or scattering material. For example, they can be made of silver, calcium carbonate (CaCO₃) and/or silicon dioxide (SiO₂), alone or in combination with resin. The scattering element can further scatter the light and mix the colors of the light so that color blocks are eliminated.

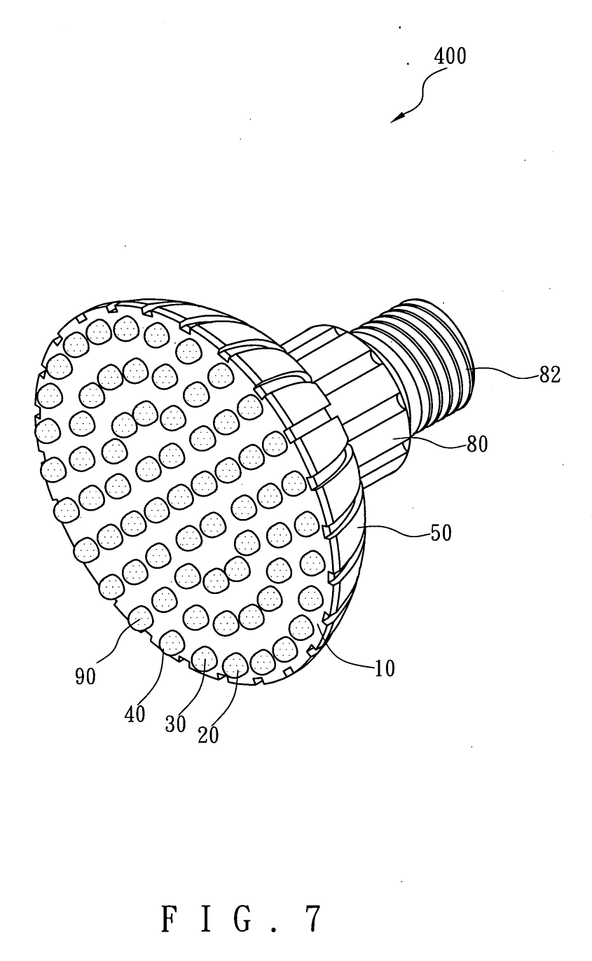

Referring to FIG. 7, shown is an LED-based lighting module 400 according to a fourth embodiment of the present invention. The LED-based lighting module 400 is identical to the LED-based lighting module 100 except two things. Firstly, a conductive device 80 is used instead of the conductive device 60. The conductive device 80 is provided with a thread 82 for engagement with a socket that is generally used to receive a typical light bulb.

Secondly, fourth-color LED packages 90 are provided on the substrate 10 in addition to the LED packages 20, 30 and 40. The fourth-color LED packages 90 are used to emit a fourth color of light. Like the LED packages 20′, 30′ and 40′, each of the LED packages 90 includes an LED chip, a lens and scattering particles.

The LED packages 90 may emit light with a wavelength of 560 nm to 610 nm. Light with a wavelength of 560 nm to 610 nm is yellow light. Yellow light is mixture of red light with green light. Yellow light can be mixed with blue light into white light.

Alternatively, the LED packages 90 may emit light with a wavelength of 470 nm to 500 nm. Light with a wavelength of 470 nm to 500 nm is bluish green light.

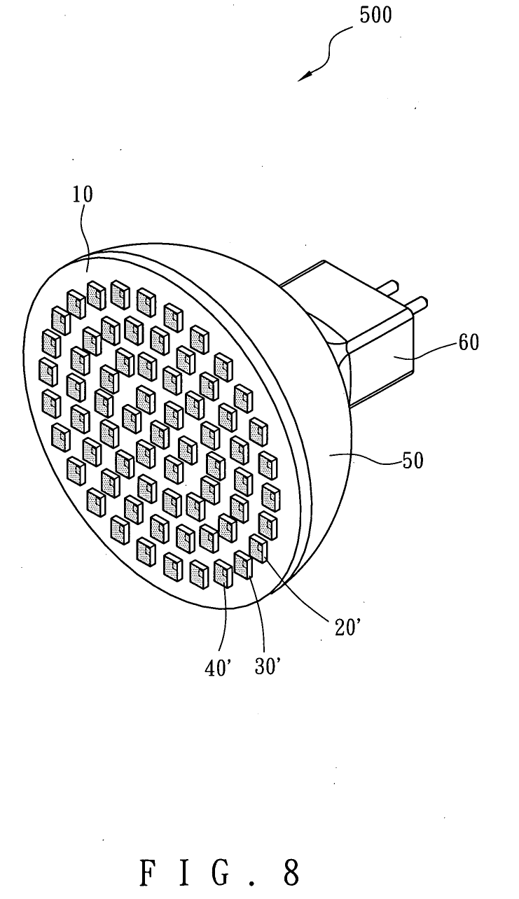

Referring to FIG. 8, shown is an LED-based lighting module 500 according to a fifth embodiment of the present invention. The LED-based lighting module 500 is like the lighting module 100 except including LED packages 20′, 30′ and 40′ instead of the LED packages20, 30 and 40, respectively. The LED packages 20′, 30′ and 40′ are surface mount device LED packages while the LED packages 20, 30 and 40 are LED lamp-typed. The LED packages 20′, 30′ and 40′ are attached to the substrate 10 different than the LED packages 20, 30 and 40 are attached to the substrate 10.

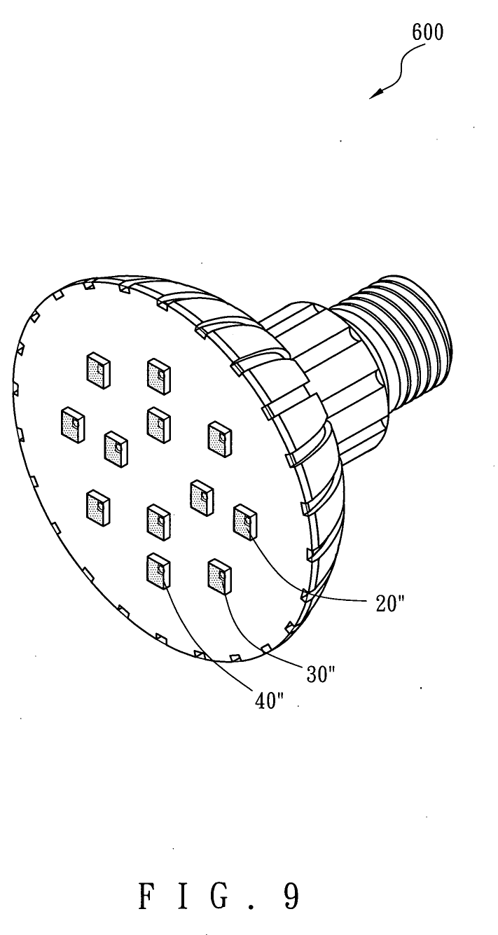

Referring to FIG. 9, shown is an LED-based lighting module 600 according to a sixth embodiment of the present invention. The LED-based lighting module 600 is identical to the LED-based lighting module 500 except including high-power LED packages 20″, 30″ and 40″ instead of the LED packages 20′, 30′ and 40′, respectively. The power of each of the high-power LED packages 20″, 30″ and 40″ is at least one watt. Thus, the number of the LED packages can be reduced.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A lighting module comprising:
a substrate;
at least three red light-emitting diode packages, three green light-emitting diode packages and three blue light-emitting diode packages provided on the substrate and each formed with a light-emitting diode chip, a lens for wrapping the light-emitting diode chip and scattering particles spread in the lens; and
a lampshade for supporting the substrate; and
a conductive device connected to the lampshade and electrically connected to the substrate for conducting electricity to the substrate from an external power supply.

2. The lighting module according to claim 1, wherein the substrate is a printed circuit board.

3. The lighting module according to claim 1, wherein the lenses are made of a material selected from a group consisting of epoxy, silicone and glass.

4. The lighting module according to claim 1, wherein the scattering particles are made of a material selected from a group consisting of a highly reflective material and a highly scattering material.

5. The lighting module according to claim 1, wherein the scattering particles are made of at least one material selected from a group consisting of silver, calcium carbonate, silicon dioxide and resin.

6. The lighting module according to claim 1, wherein the lampshade is made of an opaque material and located on a non-illuminative side of the lenses of the red, green and blue light-emitting diode packages.

7. The lighting module according to claim 1, wherein the conductive device comprises two pins electrically connected to the substrate.

8. The lighting module according to claim 1, wherein the conductive device comprises a thread for engagement with a thread formed on an internal side of a socket.

9. The lighting module according to claim 1 comprising a light-enhancing element connected to the lampshade, over the red, green and blue light-emitting diode packages.

10. The lighting module according to claim 1, wherein the light-enhancing element is made of a material selected from a group consisting of epoxy, silicone and glass.

11. The lighting module according to claim 1, wherein the light-enhancing element is a dome.

12. The lighting module according to claim 1 comprising a scattering element connected to the lampshade, over the red, green and blue light-emitting diode packages.

13. The lighting module according to claim 12, wherein the scattering element comprise:
a transparent panel connected to the lampshade, over the red, green and blue light-emitting diode packages; and
scattering particles scattered in the transparent panel.

14. The lighting module according to claim 13, wherein the transparent panel is made of a material selected from a group consisting of epoxy, silicone and glass.

15. The lighting module according to claim 13, wherein the scattering particles is made of at least one material selected from a group consisting of silver, calcium carbonate, silicon dioxide and resin.

16. The lighting module according to claim 1, wherein the red, green and blue light-emitting diode packages are light-emitting diode lamps.

17. The lighting module according to claim 1, wherein the red, green and blue light-emitting diode packages are surface-mount devices.

18. The lighting module according to claim 1 comprising a plurality of fourth-color light-emitting diode packages provided on the substrate.

19. The lighting module according to claim 18, wherein the fourth-color light-emitting diode packages are light-emitting diode lamps.

20. The lighting module according to claim 16, wherein the fourth-color light-emitting diode packages are surface-mount devices.
